(19) United States
(12) Patent Application Publication
(10) Pub. No.: US 2023/0249300 A1
(43) Pub. Date: Aug. 10, 2023

(54) MULTI-AXIS MACHINING CENTER FOR PROCESSING MULTIPLE PARTS INDEPENDENTLY

(71) Applicant: DAESUNG HI-TECH CO., LTD., Daegu (KR)

(72) Inventor: Dae Ho BAE, Daegu (KR)

(21) Appl. No.: 18/107,900

(22) Filed: Feb. 9, 2023

(30) Foreign Application Priority Data
Feb. 10, 2022 (KR) 10-2022-0017520

(51) Int. Cl. B23Q 3/157

(52) U.S. Cl. CPC B23Q 3/15713

(57) ABSTRACT

A multi-axis machining center for processing multiple parts independently includes a base frame, a processing table provided on the top of the base frame to fix a workpiece, a vertical support provided vertically on one side of the base frame, a processing part provided on the vertical support to process the workpiece, and a tool changer configured to automatically change a plurality of tools. The processing table is divided into a first table and a second table which are driven independently of each other. The processing part includes a first processing part and a second processing part provided in front of the vertical support and driven independently of each other. A first tool changer is provided on one side of the first table. A second tool changer is provided on one side of the second table.

### TECHNICAL FIELD

The present invention relates to a multi-axis machining center for processing multiple parts independently, and more particularly, a multi-axis machining center in which multiple tables and multiple processing heads are allowed to move independently so that different parts can be processed simultaneously by one machining tool and in which automatic tool changing devices are arranged on the left and right sides of the machining center so that the structure of the tool changing devices can be simplified, and the time required for tool change can be shortened to improve productivity.

### BACKGROUND ART

A machining center refers to a numerically controlled machine tool equipped with an automatic tool changer and capable of performing various types of machining on a workpiece.

Unlike general machine tools such as lathes and milling machines which have limited processing mechanisms, a machining center has an advantage of being able to perform various types of processing with one machining tool. That is, the machining center can automatically perform operations such as turning, milling, drilling, boring, and tapping with one machining tool.

The machining center can be classified into a single axis type and a multi-axis type according to the number of spindles, and can be classified into a vertical type and a horizontal type according to the installation position of spindles.

Among them, the multi-axis machining center having multiple spindles is widely used because it has an advantage of being able to process several small parts of the same type at once.

This machining center needs to selectively change various types of tools for various types of automated processing. To this end, the machining center is provided with an automatic tool changer (ATC) capable of changing a tool mounted on a spindle to a tool waiting in a tool magazine when one machining process is completed.

FIGS. 1 and 2 show an example of a vertical machining center provided with a plurality of spindles.

The vertical machining center includes a base frame 10, a processing table provided in front of the top of the base frame 10 to process a workpiece, and a support frame 30 built on the top of the base frame 10.

The support frame 30 is composed of a vertical support 32 and a horizontal support 34. In addition, a processing head 40 is provided vertically in front of the horizontal support 34 to process the workpiece fixed to the processing table 20.

FIG. 1 shows a machining center equipped with four processing heads 40. A spindle 42 is provided inside each processing head 40, and a tool T is mounted on the lower end of the spindle 42. In addition, tool changers 50 in which a plurality of tools T are accommodated are provided at the rear of the base frame 10.

The processing table 20 and the multiple processing heads 40 are disposed on the front side of the machining center with respect to the support frame 30, and the tool changers 50 are arranged in the rear space of the machining center with respect to the support frame 30.

The multiple spindles 42 are arranged in the vertical direction and configured to be vertically movable. The multiple tool changers 50 are arranged in a horizontal direction so as to exchange tools with the multiple spindles 42.

That is, if the number of spindles 42 is four, there are provided four tool changers 50. In addition, chip discharge paths 12 are provided on both sides of the processing table 20, and discharge screws 14 are provided in the chip discharge paths 12. With the above structure, chips generated during processing can be smoothly discharged.

However, in the machining center having the above structure, the processing table 20 is composed of a single table and four spindles 42 are composed of one body. As shown in FIG. 1, head supports 46 are provided on both sides of each processing head 40. As a result, the four spindles 42 can move together in the left-right direction (X direction), but the four spindles 42 cannot move independently. This structure is efficient in processing parts having the same shape but has a disadvantage in that parts having different shapes cannot be simultaneously processed in one machine tool.

In addition, since the tool changer 50 is disposed at the rear of the support frame 30, the tool of the tool changer 50 needs to be moved toward the processing head 40 in order to change the tool. This poses a drawback in that the structure for changing the tool is complicated and a separate tool changer has to be provided.

### SUMMARY

In view of the problems inherent in the related art, it is an object of the present invention to provide a novel machining center in which multiple tables and multiple processing heads can move independently.

Another object of the present invention is to provide a machining center in which multiple processing heads are allowed to move independently in a left-right direction and a vertical direction so that different parts can be processed simultaneously in one machine tool.

A further object of the present invention is to provide a machining center in which the structure of a tool changer is simplified and the time required for tool change is shortened.

In order to achieve these objects, there is provided a multi-axis machining center for processing multiple parts independently, including: a base frame; a processing table provided on the top of the base frame to fix a workpiece; a vertical support provided vertically on one side of the base frame; a processing part provided on the vertical support to process the workpiece; and a tool changer configured to automatically change a plurality of tools, wherein the processing table is divided into a first table and a second table which are driven independently of each other, the processing part includes a first processing part and a second processing part provided in front of the vertical support and driven independently of each other, a first tool changer is provided on one side of the first table, a second tool changer is provided on one side of the second table, the first tool changer is disposed on a horizontal movement path of a first head so that the first head moves toward the first tool changer to change the tools, the second tool changer is disposed on a horizontal movement path of a second head so that the second head moves toward the second tool changer to change the tools, each of the first processing part and the second processing part is configured to move in a horizontal direction along an upper guide rail and a lower guide rail provided on the front of the vertical support, a first vertical drive part is provided above the first processing part to move the first processing part in a vertical direction, a second vertical drive part is provided above the second processing part to move the second processing part in the vertical direction, each of the first vertical drive part and the second vertical drive part is composed of a vertically extending ball screw and a servomotor configured to rotate the ball screw, the first processing part includes a first head body and a first head spindle provided vertically in front of the first head body, the second processing part includes a second head body and a second head spindle provided vertically in front of the second head body, a servomotor is provided at the upper end of the first head spindle, a tool is mounted at the lower end of the first head spindle to process the workpiece fixed to the first table, a first horizontal drive part is provided at the rear of the first processing part to move the first processing part in the horizontal direction, a second horizontal drive part is provided at the rear of the second processing part to move the second processing part in the horizontal direction, the first horizontal drive part is composed of a servomotor to rotate an upper ball screw forward and backward to move the first processing part in the horizontal direction, the second horizontal drive part is composed of a servomotor to rotate a lower ball screw forward and backward to move the second processing part in the horizontal direction, a first table drive part is provided at the rear of the first table to move the first table in a front-rear direction, a second table drive part is provided at the rear of the second table to move the second table in the front-rear direction, the first table drive part is configured to rotate a left ball screw forward and backward to move the first table in the front-rear direction, the second table drive part is configured to rotate a right ball screw forward and backward to move the second table in the front-rear direction, the first tool changer includes a circular first tool disk provided on one side of the first table and configured to hold a plurality of tools thereon, the second tool changer includes a circular second tool disk provided on one side of the second table and configured to hold a plurality of tools thereon, a first drive part is provided below the first tool disk to rotate the first tool disk, a second drive part is provided below the second tool disk to rotate the second tool disk, a first control panel and a second control panel are provided separately in a control box, the first control panel is configured to control the first table, the first drive part and the first tool changer, and the second control panel is configured to control the second table, the second drive part and the second tool changer.

According to the present invention, the multiple processing heads can move independently in the vertical direction and the left-right direction so as to process a plurality of parts independently.

Further, different parts can be independently processed in one machine tool by separately driving the processing tables and allowing the multiple processing heads to move independently in the left-right direction and the vertical direction. This makes it possible to operate two machine tools in one machining center.

In particular, a workpiece which is symmetrical in the left-right direction can be processed simultaneously on the left and right sides, thereby improving productivity.

Moreover, since the tool changers are disposed on the left and right sides of the processing table, and the tool disk is rotated, it is possible to reduce the time required for tool change.

Furthermore, since there is no need to move the tool during tool change, there is no need to provide a separate tool changer.

In addition, since the processing head moves toward the tool and picks up the tool, it is possible to simplify the structure of the tool changer.

### BRIEF DESCRIPTION OF THE DRAWINGS

FIG. 1 is a perspective view showing an example of a multi-axis machining center according to the prior art.

FIG. 2 is a rear perspective view of the machining center shown in FIG. 1.

FIG. 3 is a perspective view of a multi-axis machining center according to the present invention.

FIG. 4 is a front view of the multi-axis machining center according to the present invention.

FIG. 5 is a left side view of the multi-axis machining center according to the present invention.

FIG. 6 is a left sectional view of the multi-axis machining center according to the present invention.

### DETAILED DESCRIPTION

Preferred embodiments of the present invention will now be described in detail with reference to the accompanying drawings.

In this specification, the term “front” refers to the front side of a vertical support, and the term “rear” refers to the rear side of the vertical support.

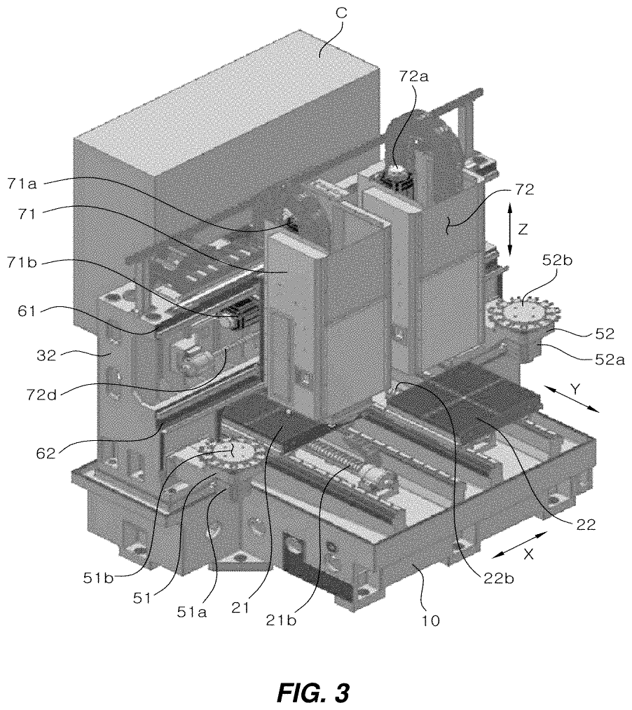

As shown in FIGS. 3 to 5, the multi-axis machining center according to the present invention includes a base frame 10, a processing table provided on the top of the base frame 10 to fix a workpiece, a vertical support 32 provided vertically on one side of the base frame 10, a processing part provided on the vertical support 32 to process the workpiece, and a tool changer configured to automatically change a plurality of tools T, wherein the processing table is divided into a first table 21 and a second table 22 which are driven independently of each other.

In addition, the processing part of the machining center according to the present invention includes a first processing part 71 and a second processing part 72 provided in front of the vertical support 32 and driven independently of each other.

In addition, a first tool changer 51 is provided on one side of the first table 21, and a second tool changer 52 is provided on one side of the second table 22. That is, according to the present invention, the first table 21 and the second table 22 driven independently of each other, and the first processing part 71 and the second processing part 72 are driven independently of each other.

With the above structure, different parts can be independently processed in one machine tool. Thus, it is possible to operate two machine tools in one machining center.

In addition, the first processing part 71 and the second processing part 72 are moved in the horizontal direction (X direction) along an upper guide rail 61 and a lower guide rail 62 provided on the front of the vertical support 32.

That is, the first processing part 71 and the second processing part 72 of the machining center according to the present invention are directly mounted on the front surface of the vertical support 32 to move along the vertical support 32.

In addition, a first vertical drive part 71a is provided above the first processing part 71 to move the first processing part 71 in the vertical direction (Z direction). Further, a second vertical drive part 72a is provided above the second processing part 72 to move the second processing part 72 in the vertical direction (Z direction). In this regard, each of the first vertical drive part 71a and the second vertical drive part 72a is preferably composed of a vertically extending ball screw and a servomotor configured to rotate the ball screw.

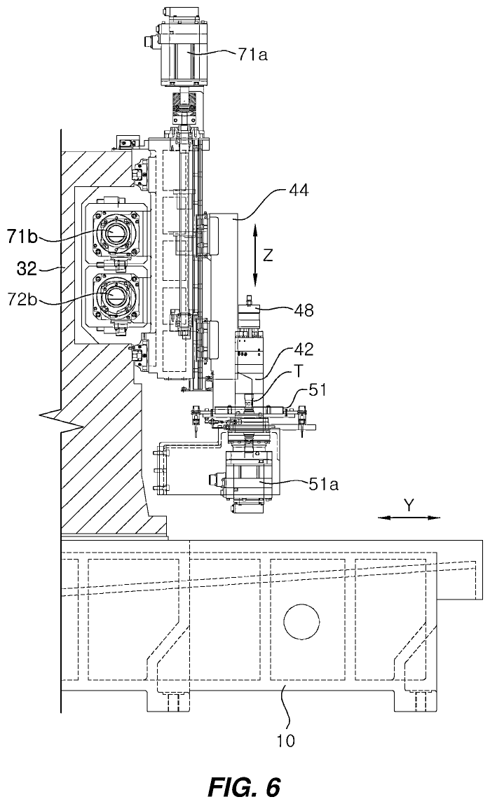

In addition, as shown in FIG. 6, the first processing part 71 is provided with a first head body 44. A first head spindle 42 is installed vertically in front of the first head body 44. That is, the first head body 44 connects the first head spindle 44 to the body in which the first vertical drive part 71a is installed.

The second processing part 72 is provided with a second head body. A second head spindle is provided vertically in front of the second head body.

A servomotor 48 is provided at the upper end of the first head spindle 42, and a tool T is mounted at the lower end of the first head spindle 42 to process the workpiece fixed to the first table 21.

Meanwhile, since the structure of the second head spindle is the same as that of the first head spindle 42, a detailed description thereof will be omitted.

With the above structure, the tool T mounted at the lower end of the first head spindle 42 can process the workpiece fixed to the first table 21, and the tool mounted at the lower end of the second head spindle 42 can process the workpiece fixed to the second table 22.

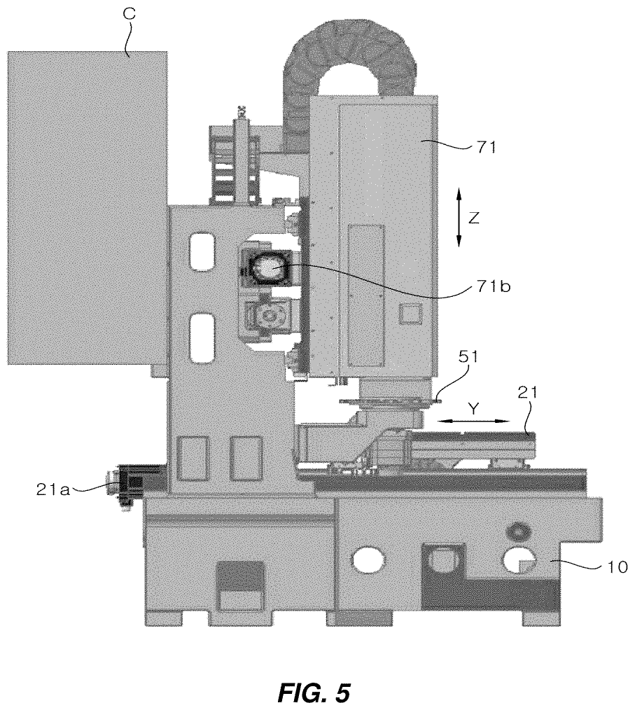

In addition, as shown in FIGS. 5 and 6, a first horizontal drive part 71b is provided at the rear of the first processing part 71 to move the first processing part 71 in the left-right direction (X direction).

Further, a second horizontal drive part 72b is provided at the rear of the second processing part 72 to move the second processing part 72 in the left and right direction (X direction).

In this regard, the first horizontal drive part 71b is composed of a servomotor to rotate an upper ball screw 71d forward and backward. Further, the second horizontal drive part 72b is composed of a servomotor to rotate a lower ball screw 72d forward and backward.

According to the structure described above, the first processing part 71 and the second processing part 72 can be independently moved in the left-right direction (X direction).

As shown in FIG. 5, a first table drive part 21a is provided at the rear of the first table 21 to move the first table 21 in the front-rear direction (Y direction). Similarly, a second table drive part is provided at the rear of the second table 22 to move the second table 22 in the front-rear direction (Y direction).

In this regard, the first table drive part 21a is composed of a servomotor to rotate the left ball screw 21b forward and backward to move the first table 22 in the front-rear direction. Similarly, the second table drive part is composed of a servomotor to rotate the right ball screw 22b forward and backward to move the second table 22 in the front-rear direction.

With the above structure, different parts can be processed on the first table 21 and the second table 22.

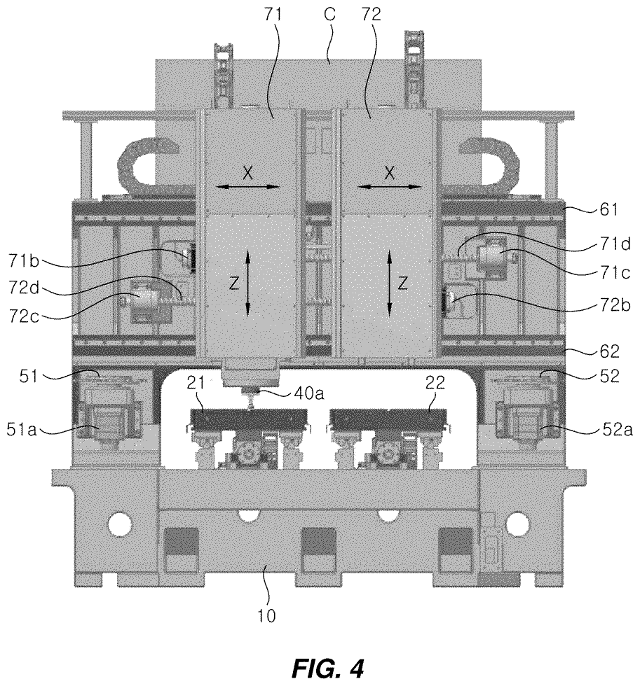

As shown in FIGS. 3 and 4, the first tool changer 51 of the machining center according to the present invention includes a circular first tool disk 51b provided on one side of the first table 21 and configured to hold a plurality of tools T thereon.

In addition, the second tool changer 52 includes a circular second tool disk 52b provided on one side of the second table 22 and configured to hold a plurality of tools T thereon.

As a result, different tools T can be arranged on the first tool disk 51b and the second tool disk 52b to process different parts.

In this regard, a first drive part 51a is provided below the first tool disk 51b to rotate the first tool disk 51b. Further, a second drive part 52a is provided below the second tool disk 52b to rotate the second tool disk 52b.

The first drive part 51a and the second drive part 52b may be composed of servomotors controlled by a control panel in a control box C. A first control panel and a second control panel are provided separately in the control box C.

In this regard, the first control panel controls the first table 21, the first drive part 71 and the first tool changer 51. The second control panel controls the second table 22, the second drive part 72 and the second tool changer 52.

Meanwhile, the tool changer of the machining center according to the present invention may adopt a multi-axis machine tool jig device having an improved pitch compensating structure disclosed in Korean Patent Application No. 10-2019-75000 filed by the present applicant. This provides an advantage in that it is easy to expand the number of tools.

If an automatic tool changer is mounted inside a column of a machining center, it is typical that a tool changer is provided between a tool magazine and a spindle.

According to the present invention, the structure of the automatic tool changer is simplified because it is not required to provide a separate tool changer.

Hereinafter, the effects of the multi-axis machining center according to the present invention will be described.

For the sake of convenience, only the process of processing the workpiece fixed to the first table 21 by mounting the tool T on the processing head of the first processing part 71 will be described.

First, in order to mount the tool T on the end of the spindle 42 of the first processing part 71, the first tool disk 51b is rotated by the first drive part 51a of the first tool changer 51 to locate a desired tool T at a designated position. That is, the first tool disk 51b is rotated so that the tool T is located at the tool change position (e.g., the central right position).

Subsequently, the first processing part 71 is moved to the left side where the tool T is located, so that the tool T is automatically mounted on the end of the processing head. When the tool is mounted, a pneumatic or solenoid type mounting method may be used. Since such a tool mounting method is well known in the art, a detailed description thereof will be omitted.

Subsequently, the first processing part 71 is moved to the right side where the workpiece is located. Then, the workpiece is processed according to the input program while rotating the tool and moving the first table 21.

At this time, the first processing unit 71 is moved in the left-right direction (X direction) and up-and-down direction (Z direction), and the first table 21 is moved in the forward and backward direction (Y direction) while fixing to the first table 21 process the workpiece.

In the case of the next processing, the first processing part 71 is moved to the left again, and then the used tool T is placed on the first tool disk 51b.

Subsequently, the first processing part 71 is lifted up to a certain height, and then the first tool disk 51b is rotated so that the tool T for the next processing is positioned below the spindle 42.

Then, the tool T is mounted on the processing head in the same way as before. The first processing part 21 is moved to the first table 21 where the workpiece is located, and the subsequent processing is performed.

Meanwhile, the second processing part 72 operates in the same manner as the first processing part 72 except that the second processing part 72 is moved to the right when changing the tool.

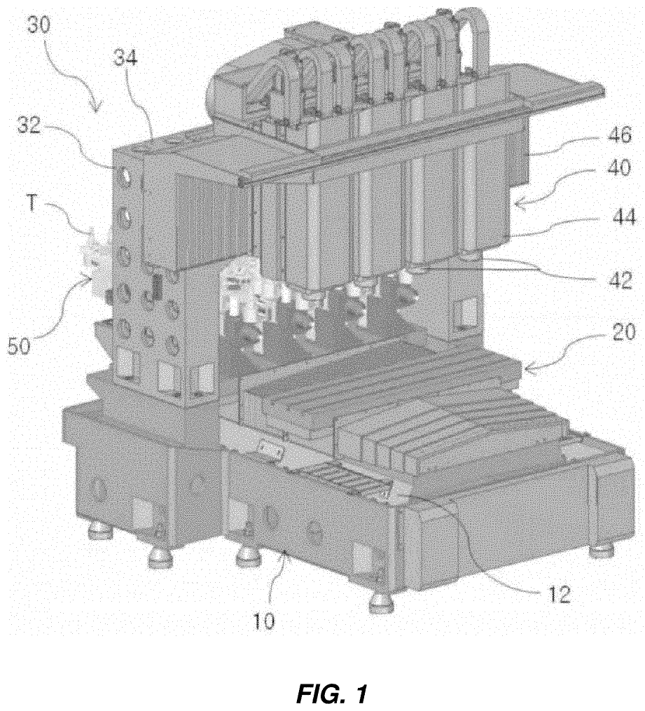

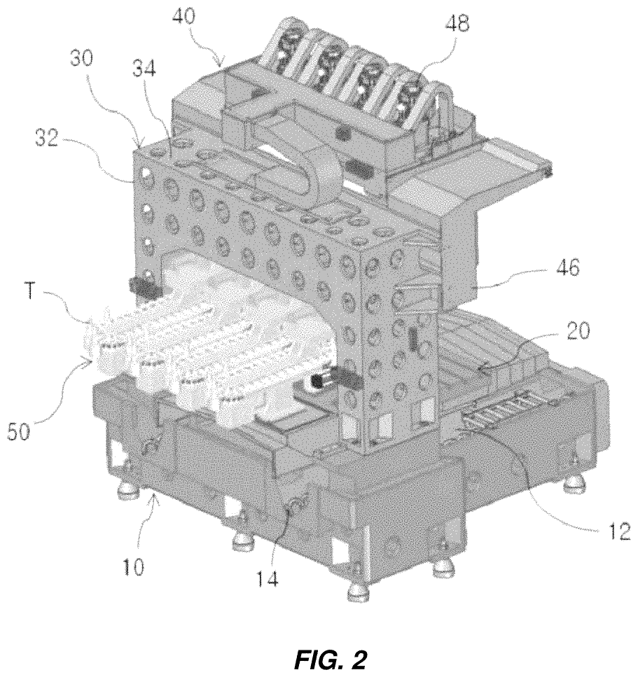

As shown in FIGS. 1 and 2, the conventional multi-axis machining center is composed of a plurality of processing heads as a unit.

That is, the multiple processing heads are configured to move simultaneously and are efficient when simultaneously processing the parts having the same shape. However, the conventional multi-axis machining center cannot simultaneously process parts having different shapes.

In addition, the automatic tool changer is provided at the rear of the conventional multi-axis machining center, and the tool is moved forward during tool change. As a result, there is a disadvantage in that the structure of the tool changer becomes complicated, and a separate tool changer has to be provided.

In contrast, according to the present invention, the first processing part 71 and the second processing part 72 are driven independently of each other, and the first table 21 and the second table 22 are also driven independently of each other. Thus, parts having different shapes can be simultaneously processed on the first table 21 and the second table 22.

In the case of a workpiece which is symmetrical in the left-right direction, the first processing part 71 can process the left portion of the workpiece on the left side and can process the right portion of the workpiece on the right side at the same time, thereby significantly improving the productivity.

In addition, the tool does not move forward during tool change, but the processing head moves to pick up the tool. This makes it possible to simplify the structure of the tool changer.

Moreover, unlike the conventional machining center, there is no need to provide a separate tool changer. This makes it possible to shorten the time required for tool change.

While the preferred embodiments of the present invention have been described above, the present invention is not limited to the above-described embodiments. Various modifications and changes may be made without departing from the scope and spirit of the present invention defined in the claims.

What is claimed is:

1. A multi-axis machining center for processing multiple parts independently, comprising:
a base frame;
a processing table provided on the top of the base frame to fix a workpiece;
a vertical support provided vertically on one side of the base frame;
a processing part provided on the vertical support to process the workpiece; and
a tool changer configured to automatically change a plurality of tools,
wherein the processing table is divided into a first table and a second table which are driven independently of each other,
the processing part includes a first processing part and a second processing part provided in front of the vertical support and driven independently of each other,
a first tool changer is provided on one side of the first table,
a second tool changer is provided on one side of the second table.

2. The multi-axis machining center of claim 1, wherein each of the first processing part and the second processing part is configured to move in a horizontal direction along an upper guide rail and a lower guide rail provided on the front of the vertical support.

3. The multi-axis machining center of claim 2, wherein a first vertical drive part is provided above the first processing part to move the first processing part in a vertical direction, and
a second vertical drive part is provided above the second processing part to move the second processing part in the vertical direction.

4. The multi-axis machining center of claim 3, wherein the first processing part includes a first head body and a first head spindle provided vertically in front of the first head body, and
the second processing part includes a second head body and a second head spindle provided vertically in front of the second head body.

5. The multi-axis machining center of claim 2, wherein a first horizontal drive part is provided at the rear of the first processing part to move the first processing part in the horizontal direction, and
a second horizontal drive part is provided at the rear of the second processing part to move the second processing part in the horizontal direction.

6. The multi-axis machining center of claim 5, wherein the first horizontal drive part is configured to rotate an upper ball screw forward and backward to move the first processing part in the horizontal direction, and
the second horizontal drive part is configured to rotate a lower ball screw forward and backward to move the second processing part in the horizontal direction.

7. The multi-axis machining center of claim 1, wherein a first table drive part is provided at the rear of the first table to move the first table in a front-rear direction, and
a second table drive part is provided at the rear of the second table to move the second table in the front-rear direction.

8. The multi-axis machining center of claim 7, wherein the first table drive part is configured to rotate a left ball screw forward and backward to move the first table in the front-rear direction, and
the second table drive part is configured to rotate a right ball screw forward and backward to move the second table in the front-rear direction.

9. The multi-axis machining center of claim 1, wherein the first tool changer includes a circular first tool disk provided on one side of the first table and configured to hold a plurality of tools thereon, and
the second tool changer includes a circular second tool disk provided on one side of the second table and configured to hold a plurality of tools thereon.

10. The multi-axis machining center of claim 9, wherein a first drive part is provided below the first tool disk to rotate the first tool disk, and
a second drive part is provided below the second tool disk to rotate the second tool disk.

11. The multi-axis machining center of claim 1, wherein a first control panel and a second control panel are provided separately in a control box,
the first control panel is configured to control the first table, the first drive part and the first tool changer, and
the second control panel is configured to control the second table, the second drive part and the second tool changer.
